(19) United States
(12) Patent Application Publication
(10) Pub. No.: US 2025/0019575 A1
(43) Pub. Date: Jan. 16, 2025

(54) PRESSURE-SENSITIVE SUPRAMOLECULAR ADHESIVES

(71) Applicant: The Regents of the University of Colorado, a body, Denver, CO (US)

(72) Inventors: Karan Vivek Dikshit, Fremont, CA (US); Aseem Milind Visal, Boulder, CO (US); Carson J. Bruns, Boulder, CO (US)

(73) Assignee: The Regents of the University of Colorado, a body, Denver, CO (US)

(21) Appl. No.: 18/771,169

(22) Filed: Jul. 12, 2024

Related U.S. Application Data
(60) Provisional application No. 63/526,313, filed on Jul. 12, 2023.

(51) Int. Cl. C09J 7/38; C09J 105/16

(52) U.S. Cl. CPC C09J 7/38; C09J 105/16; C09J 2301/302; C09J 2301/312; C09J 2301/50

(57) ABSTRACT

Bioderived pressure-sensitive adhesives. The present invention solves ongoing needs for further biofriendly adhesives. The role of mobile cross-links on the properties of a bio-friendly adhesive made using composites of cyclodextrin-based macromolecules and poly(lipoic acid) is demonstrated. Cyclodextrin-based hosts and polyrotaxanes with pendant groups of lipoic acid (a commonly ingested antioxidant) are modified to incorporate them as cross-links in poly(lipoic acid) networks obtained by simple heating in open air. By systematically varying the adhesive formulations while probing their mechanical and adhesive properties, trends in structure-property relationships that enable one to tune network properties and access bio-friendly, high-tack pressure-sensitive adhesives are shown. This invention provides bio-derived adhesive materials that are biofriendly and exhibit adhesion underwater. Multiple applications are possible including a pressure sensitive adhesive, a load bearing adhesive, an underwater adhesive, and adhesives for biomedical applications.

### CROSS-REFERENCE TO RELATED APPLICATIONS

This application claims the benefit of U.S. Provisional Application No. 63/526,313, filed Jul. 12, 2023.

### STATEMENT OF GOVERNMENT INTEREST

This invention was made with government support under grant number 2023179 awarded by the National Science Foundation. The government has certain rights in the invention.

### FIELD OF INVENTION

This invention relates to bioderived pressure-sensitive adhesives. More specifically, this invention relates to pressure-sensitive supramolecular adhesives based on lipoic acid and bio-friendly dynamic cyclodextrin and polyrotaxane cross-linkers.

### BACKGROUND OF THE INVENTION

Supramolecular adhesives have been in development since adhesion enhancements due to self-assembly were first discovered in the 1990s. Interest in these materials has surged in the past few years. Noncovalent interactions, such as hydrogen bonding, ion pairing, hydrophobic effects, metal-ligand complexation, and π-π stacking, adhere these materials to a wide variety of glass, ceramic, metal, plastic, and natural substrates. Supramolecular motifs may further confer a number of beneficial properties to adhesive materials, including the capacity for stimulus response, self-healing, high strength, and resistance to water and other solvents. Some prominent examples of supramolecular adhesives include mussel-inspired polymers functionalized with catechols (which combine several types of interactions), self-complementary hydrogen bonding pairs, such as nucleobases and urcidopyrimidanones, and a variety of macrocyclic host-guest systems.

### SUMMARY OF THE INVENTION

The present invention provides bioderived pressure-sensitive adhesives. The invention solves ongoing needs for further biofriendly adhesives.

Slide-ring materials are polymer networks with mobile cross-links that exhibit impressive stress dissipation and fracture resistance owing to the pulley effect. On account of their remarkable ability to dissipate the energy of deformation, these materials have found their way into advanced materials such as abrasion-resistant coatings and elastic battery electrode binders. In this work, we demonstrate the role of mobile cross-links on the properties of a bio-friendly adhesive made using composites of cyclodextrin-based macromolecules and poly(lipoic acid) (poly(LA)). We modify cyclodextrin-based hosts and polyrotaxanes with pendant groups of lipoic acid (a commonly ingested antioxidant) to incorporate them as cross-links in poly(lipoic acid) networks obtained by simple heating in open air. By systematically varying the adhesive formulations while probing their mechanical and adhesive properties, we uncover trends in structure-property relationships that enable one to tune network properties and access bio-friendly, high-tack pressure-sensitive adhesives. This invention provides bio-derived adhesive materials that are biofriendly and exhibit adhesion underwater. Multiple applications are possible including a pressure sensitive adhesive, a load bearing adhesive, an underwater adhesive, and adhesives for biomedical applications.

In a first aspect the present invention provides a method of preparing an adhesive film. The method includes the steps of mixing lipoated compounds with lipoic acid (LA) at mass ratios of about 4:1 to about 200:1 LA:lipoated compound in anhydrous DMSO to create an adhesive solution and casting the adhesive solution to form an adhesive film. In an advantageous embodiment the lipoated compounds can be LA-functionalized α-cyclodextrin (LACD), LA-functionalized poly(vinyl alcohol) (LAPVA), or adamantamide-capped PEG⊂(α-CD)n PRs (LAPR). The mass ratio of LA:lipoated compound can be about 99:1 to about 9:1. More broadly, the mass ratio of LA:lipoated compound is about 120:1 to about 4:1. The method of preparing an adhesive film according to the first aspect can include a step wherein the adhesive film is incubated at about 60 C or higher for 6 or more hours to evaporate DMSO and initiate the ring-opening polymerization of LA. In further advantageous embodiments the casted adhesive solution is incubated at about 70 degrees C. or higher for 8 or more hours to evaporate DMSO completely and initiate the ring-opening polymerization of LA.

In particularly advantageous embodiments the lipoated compound of the first aspect is LA-functionalized α-cyclodextrin (LACD) or adamantamide-capped PEG⊂(α-CD)n PRs (LAPR). In certain embodiments the mass ratio of LA:LACD or LA:LAPR is about 200:1 to about 4:1. In an advantageous embodiment the mass ratio of LA:LACD or LA:LAPR is about 99:1 to about 9:1.

In certain embodiments according to the first aspect the adhesive film has a thickness of about 2 millimeters (mm) or less, about 1 millimeter (mm) or less, about 750 micrometers (μm) or less, about 500 μm or less, or about 250 μm or less. In advantageous embodiments according to the first aspect the adhesive film has a thickness between about 500 μm to about 800 μm or about 400 μm to about 1 mm.

In a second aspect the present invention provides an adhesive film comprising a mixture of lipoic acid (LA) and lipoated cyclodextrin (LACD) formed into a thin sheet of about 1 millimeter (mm) or less in thickness. The sheet can have a mass ratio of LA:LACD of about 110:1 to about 90:1. Alternatively, the adhesive film according to the second aspect can employ a ratio of LA to cross-linker that is about 150 LA:1 cross-linker to about 9 LA:1 crosslinker by mass, more advantageously, about 99 LA:1 cross-linker to about 9:1 LA:1 cross-linker by mass.

Also contemplated is a method of adhering a first structure to a second structure comprising the step of adhering a first side of the adhesive film of the second aspect to a surface of the first structure and adhering a second side of the adhesive film to a surface to the second structure.

In a third aspect the present invention provides an adhesive film comprising a mixture of lipoic acid (LA) and lipoated polyrotaxane (LAPR) formed into a thin sheet of about 1 millimeter (mm) or less in thickness. The sheet can have a mass of LA:LAPR of about 110:1 to about 90:1. Alternatively, the adhesive film according to the third aspect can employ a ratio of LA to cross-linker that is about 150 LA:1 cross-linker to about 9 LA:1 crosslinker by mass, more advantageously, about 99 LA:1 cross-linker to about 9:1 LA:1 cross-linker by mass.

Also contemplated is a method of adhering a first structure to a second structure comprising the step of adhering a first side of the adhesive film of the third aspect to a surface of the first structure and adhering a second side of the adhesive film to a surface to the second structure.

### BRIEF DESCRIPTION OF THE DRAWINGS

For a fuller understanding of the invention, reference should be made to the following detailed description, taken in connection with the accompanying drawings, in which:

FIG. 1 is a graphical schematic of the process by which poly(LA) adhesives are produced upon ring-opening polymerization of LA in the presence of LA-functionalized α-cyclodextrin (LACD), LA-functionalized poly(vinyl alcohol) (LAPVA), or adamantamide-capped PEG⊂(α-CD)n PRs (LAPR) crosslinkers.

FIG. 2 is a set of photographs of adhesive formulations.

FIG. 3 is a set of images and graphs showing an overview of probe-tack testing setup and analysis. (a) Photographs of the spherical probe (with parts labeled) in the dwell and retraction phases of a probe-tack test on 99:1 LA:LAPR. (b) Conceptual schematic showing how the force vs. time data is processed to determine the relaxation time (τR) using the KWW function and work of debonding (Wdb) by integrating the area under the stress vs. displacement curve.

FIG. 4 is a pair of graphs showing a comparison of the work of debonding for all adhesive formulations with probes of (a) glass and (b) PTFE.

FIG. 5 is a pair of graphs showing the effect of aging on the work of debonding in the 99:1 LA:cross-linker adhesive.

FIG. 6 is plot of Wdb vs τ_{R} shows an inverse correlation between adhesion strength and relaxation time.

FIG. 7 is a graph showing the plotting Wdb vs stretching, suggesting that better performing adhesives have lower β values and indicating that inhomogeneities increase as the lipoic acid amounts increase formulas.

FIG. 8 is a graph showing a plot of Wdb vs G′ that shows an inverse correlation between adhesive bond strength and storage modulus at a frequency of 1 rad/s. The Dahlquist limit for adhesives is visualized by a dashed line and shading superimposed on the plot.

FIG. 9 is a set of photographs showing a demonstration of load bearing ability of 99:1 LA:LAPR using PTFE (left) and glass (right). The PTFE adhered assembly was able to bear a 100 g weight in air and water. Adhesion with glass is considerably stronger as it can bear weights of 2 kg and 4 kg, in addition to the 100 g weight in air and water.

FIG. 10 is a set of images and graphs showing the effects of retraction rate and aging on top-performing 99:1 LA:cross-linker adhesives. Photographs show the filament snap-off occurring sooner at faster retraction rates in both (a) glass and (b) PTFE probes, while the work of debonding generally increases with retraction rate on (c) glass and (d) PTFE.

### DETAILED DESCRIPTION OF THE PREFERRED EMBODIMENT

Lipoic acid (LA), a natural product and dietary supplement consumed as an antioxidant, is as a promising synthon for adhesives. The dithiolane moiety of LA undergoes ring-opening polymerization spontaneously in melt to form poly(LA) via disulfide exchange. Rich in carboxylate groups, poly(LA) demonstrates excellent adhesive properties, but only if its tendency to crystallize is suppressed by appropriate additives, such as vinylic cross-linkers and iron ions. These poly(LA) networks are simple to prepare from low-cost commercial compounds and remarkably extensible. The reversibility and redox sensitivity of the disulfide bonds in the poly(LA) backbone also imparts the adhesives with redox- and temperature-responsive behavior and the capacity for self-healing. Another promising motif for supramolecular adhesives is the bead-on-string structure of polyrotaxanes (PRs). The translation of macrocycles along a PR backbone provides an additional mechanism for stress dissipation beyond chain uncoiling and stretching. PRs can be used in a number of adhesive formulations to bond materials such as hydrogels, organogels, resins, and cells. PRs also exhibit remarkable performance as adhesive binders in Si-anode batteries due to their ability to dissipate the large stresses associated with volumetric changes at the anode. Acrylic-based pressure sensitive adhesives derived from PRs also exhibit high adhesive energies and large extensibilities attributable to ring sliding. PRs are most commonly assembled from cyclodextrin (CD) hosts, since they are commercially available, bio-friendly, and capable of threading a variety of polymer chains. However, hydrogen bonding among the CD rings imparts these PRs with low solubility and they char instead of melting, which precludes them from most conventional materials processing techniques. Therefore, CD-based PRs can be functionalized to improve their processability and functionality.

Pressure-sensitive adhesives (PSAs) are viscoelastic polymers that quickly bond with various substrates under light applied pressure due to high fluidity, elasticity, and cohesive strength. The need for bio-based and bio-friendly adhesives is of great interest because of the negative environmental impact of current petroleum-based adhesives. In this regard, poly(LA) and cyclodextrin-based compounds are both attractive because they are food-grade materials that can be sourced from renewable bio-based feedstocks. However, adhesives based on both of these polymers often compromise on sustainability through modification with petroleum-based acrylics or vinyl compounds.

We introduce new supramolecular PSA materials derived from viscoelastic LA polymers cross-linked by biofriendly cyclodextrin-based compounds in the form of either LA-functionalized α-cyclodextrin (LACD) or adamantamide-capped PEG⊂(α-CD)n PRs (LAPR). Adhesion of PSAs is strongly dominated (>99%) by the work of viscoelastic deformation during failure of the bond. Therefore, LAPR is expected to enhance energy dissipation (and therefore adhesive strength) by way of its ring-sliding motions, also known as the pulley effect, under viscoelastic deformation. α-CD hosts LA and many alkanoic acids. We also expect a binding interaction between LACD and the pentanoate side chains of poly(LA), and possibly even through-the-annulus threading during polymerization, thus providing a similar mechanism for dissipating mechanical energy through dynamic host-guest exchange. LA-functionalized poly(vinyl alcohol) (LAPVA) is included as a petroleum-based non-supramolecular control, as well as a commercial PSA (UHU Tac), for the sake of comparison. When mixed with LA at mass ratios as low as 1%, the bio-friendly supramolecular PSAs exhibit high energies of debonding from both glass and poly(tetrafluoroethylene) (PTFE) that exceed the petroleum-based controls. Overall, this work extends the reach of poly(LA) into the domain of PSAs and demonstrates that high adhesion energies can be achieved without the need for petroleum-based cross-linkers.

### Materials and Methods

Materials: 35 kDa molecular weight (MW) poly(ethylene glycol) (PEG35k) was purchased from EMD Millipore Corporation. (2,2,6,6-tetramethylpiperidin-1-yl)oxyl (TEMPO) and 1-adamantanamine hydrochloride (AdNH₂·§ HCl) were purchased from TCI America. α-Cyclodextrin (α-CD), (benzotriazol-1-yloxytris(dimethylamino)phosphonium hexafluorophosphate) (BOP) reagent, and D,L-α-lipoic acid (LA) were purchased from Chem Impex International, Inc. Ethylene diisopropylamine (EDIPA) was purchased from Alfa Aesar. Carbonyldiimidazole (CDI) and sodium hypochlorite (NaOCl) solution with 5% free chlorine was purchased from Spectrum Chemical. Sodium bromide (NaBr) was purchased from Acros Organics. Hydrochloric acid (HCl, 37%) was purchased from Sigma-Aldrich. Sodium hydroxide (NaOH), N,N-dimethylaminopyridine (DMAP), dichloromethane (CH₂Cl₂), dimethylformamide (DMF), dimethyl sulfoxide (DMSO), triethylamine (TEA) were purchased from Fisher. Ethanol (EtOH) and methanol (MeOH) were purchased from Decon Laboratories, Inc. Poly(vinyl alcohol) (PVA) (87.0-89.0% hydrolyzed, MW˜13,000-23,000) was purchased from Thermo Scientific. All materials were used as-received. Reverse osmosis (RO)-purified water was obtained from a centralized source in our campus facility through a tap. A ruby-doped glass sphere (6.35 mm diameter) used for the custom-built probe indenter was acquired from Edmund Optics (NJ, USA) and PTFE spheres (6.35 mm diameter) were obtained from McMaster Carr (IL, USA). Cellulose membrane tubing (1 inch diameter) with a molecular weight cut-off (MWCO) of 3500 was purchased from Sigma Aldrich.

### Synthetic Procedures

Synthesis of unmodified polyrotaxane (uPR): Adamantane (Ad)-capped unmodified polyrotaxane (AdPR) was synthesized from poly(ethylene glycol)dicarboxylate (PEGDC), α-CD, and adamantamine (AdNH₂).

Synthesis of PEGDC: PEG (10 g, MW=35 k, 0.3 mmol) was dissolved in RO water (100 mL) maintained at pH 10 with 1 M NaOH solution (100 μL). TEMPO (100 mg, 0.6 mmol), NaBr (100 mg, 1 mmol), and NaOCl solution (15 mL) were added and the reaction was stirred at room temperature (RT) for 20 min. EtOH/MeOH, equal in amount to NaOCl solution, was added to quench any unreacted NaOCl, followed by dropwise addition of HCl (0.003 M) until the pH was <2, in order to ensure protonation of PEGDC. The polymer was extracted from the aqueous solution into CH₂Cl₂ (3×100 mL) and dried under a constant stream of air. The residue was dissolved in hot EtOH (200 mL) followed by overnight refrigeration to precipitate PEGDC, which was collected by vacuum filtration and dried under vacuum at 60° C. to yield PEGDC (6 g, 60%) as a white powder, which was used without further purification.

Synthesis of AdPR: AdPR was synthesized by a modified literature procedure. [Araki, J.; Zhao, C.; Ito, K. Efficient Production of Polyrotaxanes from α-Cyclodextrin and Poly(ethylene glycol). Macromolecules 2005, 38, 7524-7527] PEGDC (3 g, 0.09 mmol) was dissolved in RO water (100 mL) and maintained at 80° C. with stirring. α-CD (12 g, 12 mmol) was added and the solution was stirred for 30 min until it was no longer turbid. The solution was placed in a refrigerator at 4° C. overnight to precipitate the PEG C (α-CD), inclusion complex, or pseudo-polyrotaxane (pseudoPR), which was isolated as a white powder by lyophilization (Labconco FreeZone 4.5 L benchtop model) and used without further purification. The crude pseudoPR (˜10 g) was dispersed in anhydrous DMF (100 mL). BOP reagent (0.48 g, 1.1 mmol), AdNH₂ (1.6 g, 1.1 mmol)—obtained from AdNH₂·HCl by washing with aqueous NaOH, extraction in CH₂Cl₂, and drying by rotary evaporation—and EDIPA (200 μl, 1.1 mmol) were added to the slurry and the mixture was stirred at RT for 30 min. The slurry was placed in a refrigerator at 4° C. overnight to stopper the pseudoPR, affording the crude unmodified polyrotaxane (uPR). The resulting polymer was purified by centrifugal washing with water, followed by MeOH. The product was dried under vacuum at 70° C. overnight, dissolved in DMSO at a concentration of 10% w/v, and the same precipitation, centrifugation, and drying procedure was repeated a second time to obtain AdPR as a white solid (5.6 g, 48%). The 1H NMR spectrum of AdPR, consistent with literature, was used to estimate an inclusion ratio of ˜27% (corresponding to approximately 106 α-CD rings per chain) by comparative signal integration of the Ad and α-CD resonances. The molecular weight (MW) of PR was estimated by 1H NMR spectroscopy to be ˜138 kDa, in good agreement with the MW estimation of ˜130 kDa by gel permeation chromatography (GPC).

### Synthesis of Lipoated Cross-Linkers

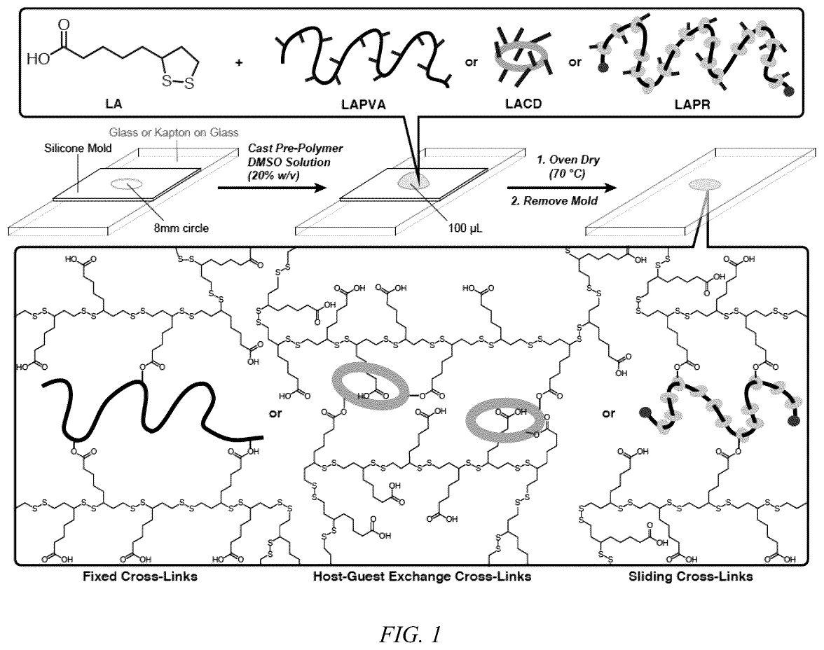

Lipoation of α-cyclodextrin (α-CD), and poly(vinyl alcohol) (PVA), and polyrotaxane (AdPR) was achieved by esterification of the pendant alcohol moieties of each scaffold (Scheme S1—see FIG. 1).

Lipoated Polyvinyl Alcohol (LAPVA): A round bottom flask was charged with ˜88% hydrolyzed PVA (2 g, 130 μmol, DP˜500) and 50 mL anhydrous DMSO and the mixture was stirred under one atmosphere of nitrogen. A solution of LA (10 g, 50 mmol) in anhydrous DMSO (25 mL) was added, followed by EDC·HCl (9.6 g, 50 mmol) and TEA (3.6 mL, 28 mmol). The reaction was stirred for 3 days at 35° C. under nitrogen. The product was precipitated in excess MeOH (500 mL), washed over 3 cycles of centrifugation (10 minutes at 3,000 rpm) in MeOH, and dried under vacuum at room temperature overnight to obtain LAPVA as a brown-colored solid (4 g). The increase in number-averaged MW of ˜3,000 mass units determined by GPC corresponds to an average gain of ˜15 LA units, in good agreement with the ˜3% modification ratio determined by NMR signal integration of selected lipoate and OH signals.

Lipoated Cyclodextrin (LACD): α-CD (2 g, 2 mmol) was dissolved in 50 mL anhydrous DMSO and maintained at 35° C. while stirring under an atmosphere of nitrogen. LA (6 g, 28 mmol) was dissolved separately in anhydrous DMSO (50 mL) under the same conditions. The LA solution was added to the α-CD solution, followed by EDC. HCl (5.6 g, 28 mmol) and TEA (2 mL, 28 mmol). The reaction was stirred for 3 days at 35° C. under nitrogen. The crude reaction mixture was poured into MeOH (500 mL) and washed over three cycles of centrifugation in MeOH (decanting and replacing the supernatant each time) to obtain a pellet, which was dried under vacuum (overnight) without application of heat to obtain LACD as yellow-tinted white solid (1.2 g). The extent of lipoation was estimated by 1H NMR spectroscopy to be ˜10 LA groups per CD ring. The NMR spectrum shows signal broadening indicative of self-assembly, consistent with the self-assembly of LAC α-CD host-guest complexes. Two highly upfield-shifted signals (7.5-8.0 ppm) are consistent with thiol-thiolate hydrogen bonds. Since these signals are not observed in LAPVA and LAPR, the stabilization of these hydrogen bonds is likely facilitated by the cavity of the CD host.

Lipoated Polyrotaxane (LAPR). AdPR (2 g, 7 μmol) was dissolved in 50 mL anhydrous DMSO and maintained at 35° C. while stirring under nitrogen. LA (6 g, 28 mmol) was dissolved in anhydrous DMSO (50 mL) under the same conditions. Upon complete dissolution of the AdPR, the LA solution was added, followed by EDC·HCl (5.6 g, 28 mmol) and DMAP (3.6 g, 28 mmol). The reaction was stirred for 3 days at 35° C. under nitrogen. An aqueous 1 M NaOH solution (30 mL) was added to the reaction and the contents of the reaction vessel were dialyzed (3,500 MWCO cellulose membrane tubing) for 3 days against RO water (4 L) to remove unreacted sodium lipoate, replacing the bath with fresh water twice a day. The dialized aqueous solution was lyophilized to obtain a brown solid (2.1 g). The extent of lipoation was estimated by NMR to be ˜0.9 LA groups per CD ring, corresponding to ˜95 LA groups per PR molecule.

### Synthesis of LA-Based Adhesives

The lipoated compounds (LACD, LAPVA, or LAPR) were mixed with lipoic acid at mass ratios of 0:1, 4:1, 9:1, 99:1, and 1:0 in ˜2 mL of anhydrous DMSO at a concentration of 20% w/v. After stirring the solutions overnight at ˜80° C., 100 μL of the homogeneous solution was cast into a circular silicone mold (8 mm diameter×500 μm thickness) on top of polyimide tape (Kapton, used to transfer samples onto the adhesive testing setup) affixed to a glass microscope slide, avoiding air bubbles at the interface, and placed in an oven maintained at 70° C. for approximately 4 h. This cast-and-dry procedure (see Scheme 1/FIG. 1) was repeated twice to increase the thickness of the resulting adhesive films. After the final casting step, the samples were left in a vacuum oven at 70 C for ˜12 hours to evaporate DMSO completely and initiate the ring-opening polymerization of LA, which only occurs above its melting point of ˜70° C. Sample thicknesses, determined by the dynamic mechanical analyzer while pre-indenting the sample until a non-zero force is observed, varied between 500-800 μm. The pre-adhesive solutions were also cast directly on glass to capture photographs (see FIG. 1) of the adhesives without the yellow background color of Kapton, and for the load-bearing tests.

### Characterization Procedures

NMR Spectroscopy: Nuclear Magnetic Resonance (NMR) spectroscopy was performed on a Bruker Avance-III 300 MHz NMR spectrometer at room temperature and spectra were analyzed in MestReNova software (v14). The spectra were referenced to the residual solvent signal (2.50 ppm for (CD₃)₂SO).

Gel Permeation Chromatography: Gel permeation chromatography (GPC) was performed on a Tosoh EcoSEC 8320 system equipped with columns for DMSO as the solvent. MW estimates were determined using PEG standards of known MW as calibrants in DMSO.

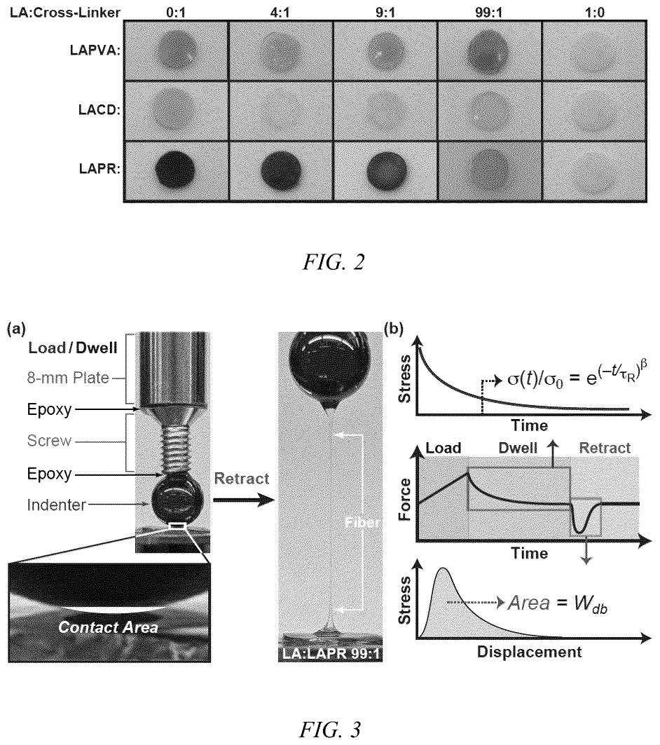

Probe-Tack Tests: The work of debonding for all of the adhesive formulations were measured using a dynamic mechanical analyzer (Anton Paar MCR-702) with a custom-built compression plate that serves as a probe indenter. The indenter fabrication and testing was similar to protocols reported in the literature. [Darby, D. R.; Lai, E.; Holten-Andersen, N.; Pham, J. T. Interfacial Adhesion of Fully Transient, Mussel-Inspired Hydrogels with Different Network Crosslink Modalities. Ad-vanced Materials Interfaces 2021, 8, 2100319; Darby, D. R.; Cai, Z.; Mason, C. R.; Pham, J. T. Modulus and adhesion of Sylgard 184, Solaris, and Ecoflex 00-30 silicone elastomers with varied mixing ratios. Journal of Applied Polymer Science 2022, 139, e52412.] The probe was constructed by bonding either a glass or PTFE (6.35-mm diameter) sphere securely on a flathead screw with high weld strength epoxy glue (J-B ClearWeld) and allowed to cure for at least 1 hour. Upon ensuring sufficient adhesion between the sphere and screw, the screw side of the assembly was affixed to an 8-mm rheometer parallel plate (Anton Paar) with the epoxy glue. The schematic in FIG. 3a illustrates the construction of the probe.

Thermal behavior: Melting point and glass transition of the adhesives were measured using differential scanning calorimetery (DSC). DSC Q2000 (TA Instruments) with a constant supply of nitrogen was used to perform a heating run on the samples to determine the glass transition temperature (T_{g}) and melting behavior. A ramp rate of 10 C was used to heat the sample from −80° C. to 100° C. Degradation profile of the adhesives was determined by thermogravimetric analysis (TGA). TGA 5500 (TA instruments) was used to heat the samples from room temperature to 600° C. to elucidate the degradation behavior. The degradation profiles confirms that the samples were cast at a reasonable temperature to ensure thermal stability of the adhesives. The highest temperature used for DSC studies is also within the stable temperature window.

X-ray scattering: Presence of crystals in the adhesive specimens was confirmed using Forvis Technologies wide-angle X-ray scattering (WAXS) 30 W Xenocs Genix3D X-ray source (Cu anode, wavelength λ=1.54 A) and Dectris Eiger R 1 M detector. The data were collected at a sample-to-detector distance of 145.66 mm, while the samples were exposed to X-rays for 3 minutes. The presence of an ordered, crystalline structure in cast lipoic acid samples was confirmed by the sharp peaks in the spectra. The addition of lipoated cross-linkers disrupts the crystallinity and less intense peaks or an amorphous broad peak is observed. X-ray spectra post-aging of the samples shows clear, sharp peaks in addition to the earlier amorphous, broad peaks indicating evolution of crystals with aging.

Rheology: The rate-dependent properties of the adhesive formulations were characterized by shear rheology on an Anton-Paar MCR-702 rheometer. Amplitude sweeps in the strain range of 0.001-0.1% were carried out for all adhesive samples to ascertain the linear viscoelastic (LVE) limit. The exception to this strain range was the commercial adhesive (UHU Tac) used for comparison, which required a lower strain range of 0.0001-0.01% to determine the LVE. A strain (varying between 0.01-0.05%) well within the respective LVE limits of the samples was chosen to perform frequency sweeps. The storage (G′) and loss (G″) moduli were recorded as a function of frequency between 0.1-100 rad/s. An 8-mm parallel plate was used to deform and record mechanical spectra while a 25-mm plate served as the bottom plate. To align with the conditions for probe-tack tests, all rheological experiments were carried out at room temperature (22° C.+/−1° C.).

### EXAMPLES

The present invention provides advanced pressure-sensitive adhesives (PSAs) based on poly(lipoic acid) using only bio-friendly materials. In the approach, we prepared several lipoated additives derived from biocompatible scaffolds—α-CD, PVA, and PR—to be employed as cross-linkers in the ring-opening polymerization of LA.

Example 1—Synthesis of Lipoated Cross-Linkers: Cross-linkers are employed in poly(LA) adhesives to increase MW and prevent depolymerization. In order to synthesize poly(LA) adhesives with bio-friendly cross-linkers, we functionalized the α-CD, PVA, and AdPR scaffolds via esterification of their hydroxyl groups with lipoic acid and EDC·HCl (see Scheme 1/FIG. 1). The successful lipoation of each compound was confirmed by 1H NMR spectroscopy and GPC. Lipoated PVA (LAPVA) was isolated with an average of ˜15 LA groups per macromolecule. LAPVA was prepared as fixed-crosslink control for comparison with the host-guest cross-linker comprising lipoated α-CD (LACD), which was isolated with an average of ˜10 LA groups per molecule, as well as a sliding-crosslink scaffold based on lipoated polyrotaxane (LAPR), which was obtained with an average of ˜0.9 CD rings per chain, corresponding to ˜95 LA groups per macromolecule.

Example 2—Library of LA-Based Adhesive Formulations: We leverage the thermally activated self-polymerization of LA in the presence of lipoated cross-linkers to prepare adhesive viscoelastic polymers. We prepared mixtures of LA with each cross-linker at mass ratios of 0:1, 4:1, 9:1, 99:1, and 1:0 in concentrated DMSO solutions (20% w/v). These solutions were cast in a circular silicone mold on Kapton tape or glass and oven-dried at 70° C. (above the melting point of LA) to obtain the adhesives (Scheme 1/FIG. 1). The drying temperature is not expected to degrade the adhesive sample as the TGA, from RT to 600° C., does not indicate degradation until about 150° C. Since each cross-linker is decorated with multiple pendent LA groups, we expect their dithiolane moieties to become incorporated randomly in the poly(LA) chains, similar to the configurations described by Endo et al., as they grow and exchange bonds during thermal self-polymerization, resulting in a branched macromolecular architecture (Scheme 1/FIG. 1). [Endo, K.; Yamanaka, T. Copolymerization of lipoic acid with 1, 2-dithiane and characterization of the copolymer as an interlocked cyclic polymer. Macromolecules 2006, 39, 4038-4043.] Photographs of each adhesive polymer on glass are shown in FIG. 2. The 1:0 sample of pure poly(LA) crystallizes rapidly and appears opaque, unlike the cross-linked mixtures which are more transparent, indicating lower crystallinity. We observed that the cross-linked mixtures also become more opaque over time (1-3 weeks), except for those based on LAPR, which retain their translucent appearance for at least 4 months.

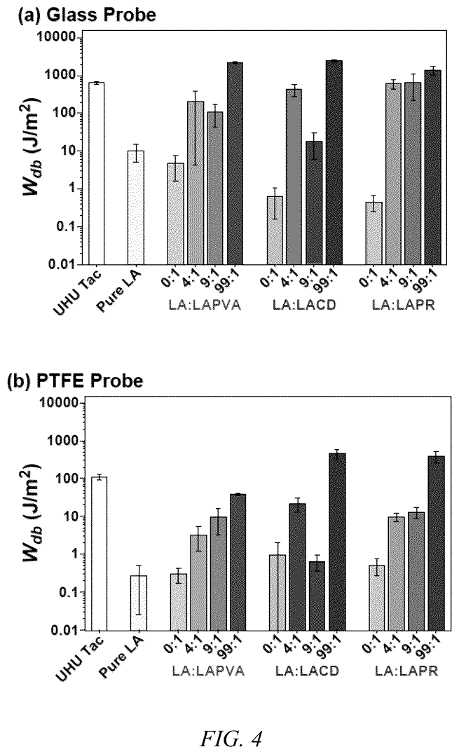

Example 3—Probe-Tack Tests on Glass and PTFE: We employed 6.35-mm spherical probes of glass or PTFE to evaluate the adhesion of the formulations on a dynamic mechanical analyzer, inspired by recent reports employing spherical probes. [Darby, D. R.; Lai, E.; Holten-Andersen, N.; Pham, J. T. Interfacial Adhesion of Fully Transient, Mussel-Inspired Hydrogels with Different Network Crosslink Modalities. Advanced Materials Interfaces 2021, 8, 2100319; Darby, D. R.; Cai, Z.; Mason, C. R.; Pham, J. T. Modulus and adhesion of Sylgard 184, Solaris, and Ecoflex 00-30 silicone elastomers with varied mixing ratios. Journal of Applied Polymer Science 2022, 139, e52412; Takahashi, K.; Oda, R.; Inaba, K.; Kishimoto, K. Scaling effect on the detachment of pressure-sensitive adhesives through fibrillation characterized by a probe-tack test. Soft Matter 2020, 16, 6493-6500.] The probe-tack tests are divided into three stages (see three groupings, such as in FIG. 4b): load, dwell, and retract. First, the probe is brought into contact with the surface while being lowered slowly until a non-zero force (˜0.01 N) is registered. The sample is then indented to a depth of 20 μm over 0.5 s (“loading”). Then, in the dwelling stage, the loaded sample is allowed to relax for 120 s while measuring data on the attenuation of force. Finally, the probe is immediately retracted at a rate of 0.1 mm/s until adhesive failure or a displacement of 50 mm (whichever occurs first) at a rate of 0.1 mm/s. Representative photographs of indentation and retraction of LA/LAPR 99:1 are shown in FIG. 3a. Force is measured as a function of time throughout the test. The work of debonding (W_{db}) is calculated from the retraction data and the relaxation time (τ_{R}) is calculated from the dwell data.

Example 3—Work of Debonding: We measure the work of debonding (W_{db}) as an indicator of adhesive strength. The W_{db} values are calculated by integration of the stress vs. displacement graphs generated during retraction of the probe. Each probe-tack test was repeated in triplicate and the average W_{db} values were compared on glass (FIG. 4a) and PTFE (FIG. 4b). Several clear trends are observed with respect to the effect of LA:cross-linker ratio and substrate material.

Example 4—Effect of LA: Cross-Linker Ratio on Glass: In general, the work of debonding increases substantially with increasing LA content, but pure LA is a poor adhesive (W_{db}≈10) owing to its crystallinity. The 99:1 LA:cross-linker mixtures exhibit the highest Wdb values in all cases. On glass, all three 99:1 formulas show very strong adhesion, with W_{db} values exceeding 1000 J/m2, higher than the commercial PSA (UHU Tac, W_{db}≈900 J/m2). Among all of the PSAs we tested, the 99:1 LA:LACD formula forms the strongest bond with an average work of debonding of 2500 J/m2. However, the LA:LAPR mixtures are the least sensitive to the cross-linker ratio, with the 4:1 and 9:1 formulas each matching UHU Tac, which is 5-6-fold stronger than the corresponding 4:1 and 9:1 LAPVA adhesives.

Example 5—Effect of the Substrate Material: PTFE is an inert, hydrophobic polymer with low surface energy commonly used as a non-stick coating. As expected, W_{db} is lower on PTFE for all formulations, with the exception of the pure LACD and pure LAPR films, which are poor adhesives (W_{db}<1 J/m²) on both glass and PTFE. Unlike the case of glass, the biofriendly 99:1 mixtures based on the supramolecular LACD and LAPR scaffolds outperform 99:1 LA:LAPVA by an order of magnitude on PTFE, each with remarkably strong bonds (W_{db}≈400), also four-fold stronger than UHU Tac. PTFE reduces the work of debonding by a factor of ˜4 in 99:1 LA:LACD and LA:LAPR, compared to a factor of 37 for LA:LAPVA.

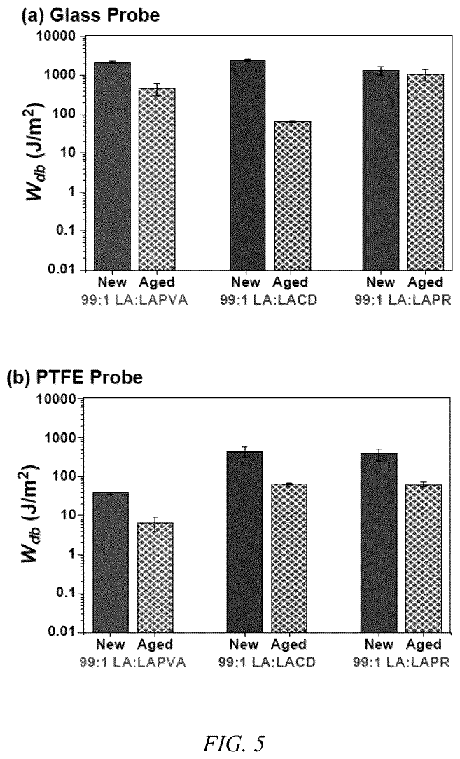

Example 6—Effect of Aging: Without cross-links, poly(LA) crystallizes within minutes below its melting temperature as a result of nucleating oligomers that drive ring-closing depolymerization of longer polymer chains with terminal radicals. The absence of crystals in majority of the adhesive formulations was determined by the DSC and XRD. Since vinylic monomers are not employed to capture these radicals and stabilize the polydisulfide chains, it was necessary to determine if aging could diminish adhesive performance by way of crystallization. The work of debonding in fresh samples (aged a few hours after removing from the oven) and aged samples (incubated in ambient air for 4 weeks) is compared for each of the 99:1 LA:cross-linker formulas on glass and PTFE in FIG. 5. All of the aged samples exhibit diminished W_{db} values, but the extent of attenuation varies considerably. On glass (FIG. 5a), the aged 99:1 LA:LAPR does not suffer a statistically significant loss in adhesion, whereas W_{db} drops down to 450 and 70 J/m2 in the aged 99:1 formulas of LAPVA and LACD, respectively. By contrast, on PTFE the W_{db} values observed for PSAs based on LACD and LAPR are almost identical before and after aging, each falling to ˜70 J/m² upon aging. W_{db} is diminished to a similar extent, from ˜400 to ˜70 J/m², in the less adhesive 99:1 LA:LAPVA sample upon aging. Microstructural analysis performed using XRD revealed development of an ordered structure with time; the evolution of an ordered crystalline structure was further confirmed from the heat of fusion of the melting peaks observed in DSC. Prominent peaks are observed at 2θ values of 17, 18.5, 21 and 22. The absence of peaks in fresh samples and eventual appearance of the characteristic peaks indicates crystal growth with aging. The heat of fusion values of the endothermic melting peak in DSC also increase with aging and corroborate the crystallography data. We conclude that all of the adhesive formulas undergo molecular rearrangements that degrade adhesive performance, likely owing to the slow formation of micro-crystalline domains, but this undesirable effect is highly suppressed by the polyrotaxane cross-linker, at least when bonding to glass.

Example 7—Stress Relaxation: Stress relaxation data can provide insight into an adhesive's internal processes on the molecular scale. For example, the self-diffusivity of polymers is inversely proportional to the relaxation time τ_{R}. Larger self-diffusivity values contribute to high molecular mobility which endows an adhesive with the ability to comply and exhibit good tensile strain. The ability of a soft material to relax fast allows it to “switch” easily between the elastic state and viscous state. PSAs should be able to dissipate any deformation in the adhered state, but also retain micro- and macrostructure during debonding, which is why they are viscoelastic in nature and possess fast relaxation times. Fast relaxation times ensure that the PSA can deform quickly enough to form a good interfacial contact with the substrate, and also minimize the transfer of adhesive material to the bonded substrate.

We estimated relaxation times (τ_{R}) in our adhesives by fitting the dwell curves to the empirical stretched exponential Kohlrausch-Williams-Watts (KWW) function:

$$\frac{σ ( t )}{σ ( 0 )} = e \text{?} \qquad ( 1 )$$

$$\text{?} \text{indicates text missing or illegible when filed}$$

where t is time and β is a stretching factor used to indicate the broadness of the relaxation process associated with τ_{R}. [Gotze, W.; Sjogren, L. Relaxation processes in supercooled liquids. Reports on Progress in Physics 1992, 55, 241; Goodwin, A. A.; Simon, G. P. Dynamic mechanical relaxation behaviour of poly (ether ether ketone)/poly (etherimide) blends. Polymer 1997, 38, 2363-2370.] The Maxwell stress relaxation function (σ(t)/σ(0)=e^{(-t/τ}R)) did not produce a good fit (R²<0.6) implying that the relaxation observed in the LA-based adhesives is not governed by a single relaxation process, but could arise instead from multiple coupled processes. The KWW equation has been widely used to model nonlinear processes in polymeric and soft material systems. [Liu, J.; Lin, P.; Li, X.; Wang, S.-Q. Nonlinear stress relaxation behavior of ductile polymer glasses from large extension and compression. Polymer 2015, 81, 129-139; Tang, S.; Wang, M.; Olsen, B. D. Anomalous self-diffusion and sticky Rouse dynamics in associative protein hydrogels. Journal of the American Chemical Society 2015, 137, 3946-3957; Bandyopadhyay, R.; Mohan, P. H.; Joshi, Y. M. Stress relaxation in aging soft colloidal glasses. Soft Matter 2010, 6, 1462-1466.] The KWW function applied to latex adhesives has revealed the effect of atmospheric conditions, additive concentration, and substrate effects on the cooperativity of their relaxation processes. [Lopez-Suevos, F.; Frazier, C. E. Wood-adhesive interactions in a PVAc latex. Holzforschung 2008, 62, 468-471.] Small-scale localized motions can also be distinguished from larger segmental motions using KWW relaxation. τ_{R} have been shown to increase and β values decrease as more cross-links were introduced. [Jose, J.; Swaminathan, N. Response of adhesive polymer interfaces to repeated mechanical loading and the spatial variation of diffusion coefficient and stresses in a deforming polymer film. Physical Chemistry Chemical Physics 2019, 21, 11266-11283.] The reduction in β values indicates a diminishing cooperativity between polymer segments, associated with retardation of segmental relaxation due to cross-linking.

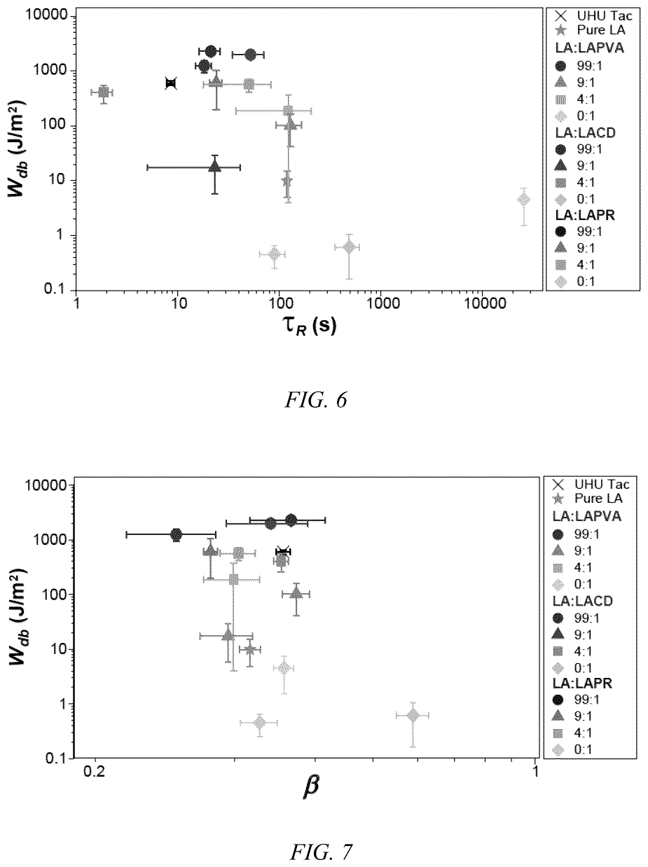

The effect of stress relaxation in PSAs is not yet completely understood. τ_{R} and adhesion energy are well-correlated in some PSAs, but uncorrelated in others. In the case of our LA-based adhesives, the work of debonding tends to increase with decreasing relaxation times (FIG. 6). With the exception of 99:1 LA:LAPVA, the high-LA-content adhesives exhibit short relaxation times (τ_{R}<30 s), as does the commercial adhesive sample (UHU Tac, τ_{R}=8.5 s). The shorter relaxation time manifests as a “snap-off” when an adhesive is retracted at a faster rate. Likewise, the poor adhesives with low LA content exhibit much longer relaxation times, interfering with their ability to rapidly dissipate energy.

The cooperativity of the adhesives (as indicated by the magnitude of β) appears inconsistent within each adhesive series, but in general the β values decrease as lipoic acid content increases (FIG. 7). The reduction in β values suggests an increase in dynamic and/or structural inhomogeneity, which may also enhance adhesion. Inhomogeneities in the samples could arise from the dangling poly(lipoic acid) chains, due to the incomplete gelation of LA, or poly(lipoic acid) cyclic polymers which form in the case of racemic mixtures of LA. Thus, the stress relaxation data obtained from the probe-tack tests indicates that the strongest adhesives generally have shorter relaxation and more network inhomogeneities.

Rate-Dependent Investigations of the Adhesives: Since the dynamic mechanical properties of viscoelastic polymers are frequency dependent, it follows that their adhesion properties are likewise rate dependent. We investigated the rate dependence of our adhesive formulas by shear rheology and probe-tack tests of increasing retraction rate.

Example 8—Shear Rheology: The correlation between viscoelastic moduli and adhesion has been established since the pioneering work of Dahlquist in the 1960s. [Chang, E. P. Viscoelastic properties of pressure-sensitive adhesives. The Journal of Adhesion 1997, 60, 233-248; Taghizadeh, S. M.; Ghasemi, D. Rheological and adhesion properties of acrylic pressure-sensitive adhesives. Journal of Applied Polymer Science 2011, 120, 411-418; Dahlquist, C. A. Pressure-sensitive adhesives. Treatise on Adhesion and Adhesives 1969, 2, 219-260.] We employed shear rheology to further investigate correlations between the mechanical properties of the poly(LA) formulas and their adhesion on glass. Frequency sweeps carried out at room temperature (22° C.+/−1° C.) over a frequency range of 0.1-100 rad/s with the LA:LAPVA, LA:LACD, and LA:LAPR mixtures all show that the networks soften with increasing LA content. The strain was below the linear viscoelastic limit in all frequency sweeps, as determined by amplitude sweeps in the range of 0.001-0.1%.

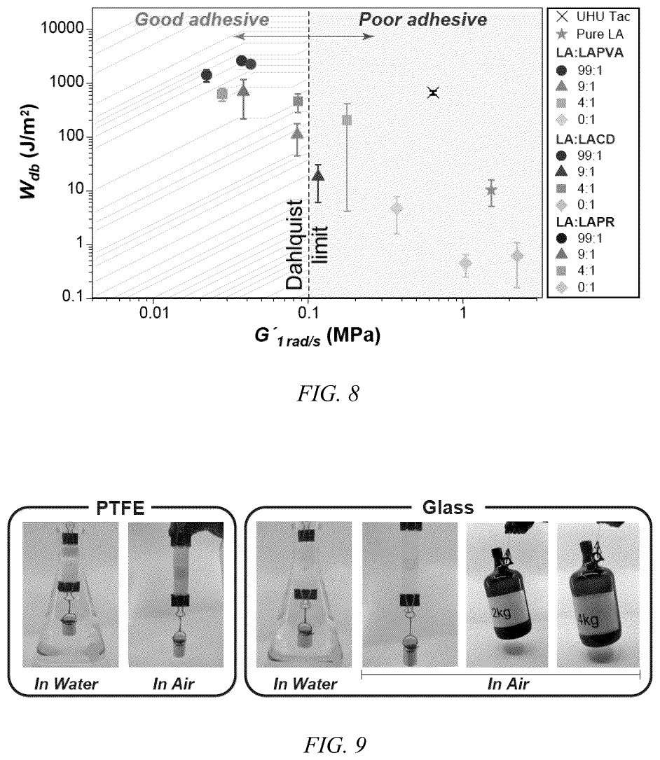

The work of debonding is plotted against the storage modulus at a frequency of 1 rad/s (G′_{1 rad/s}) in FIG. 8, revealing an inverse correlation between W_{db} and (G′_{1 rad/s}). These expected results can be explained by the phenomenological Dahlquist criterion, which suggests that superb adhesives are soft, with moduli of ≤0.1 MPa. [Dahlquist, C. A. Pressure-sensitive adhesives. Treatise on Adhesion and Adhesives 1969, 2, 219-260.] The dynamic mechanical properties of the inspirational poly(LA) adhesives treated with divinyl and iron cross-linkers also meet the Dahlquist criterion for soft adhesives. [Zhang, Q.; Shi, C.-Y.; Qu, D.-H.; Long, Y.-T.; Feringa, B. L.; Tian, H. Exploring a naturally tailored small molecule for stretchable, self-healing, and adhesive supramolecular polymers. Science Advances 2018, 4, eaat8192.]

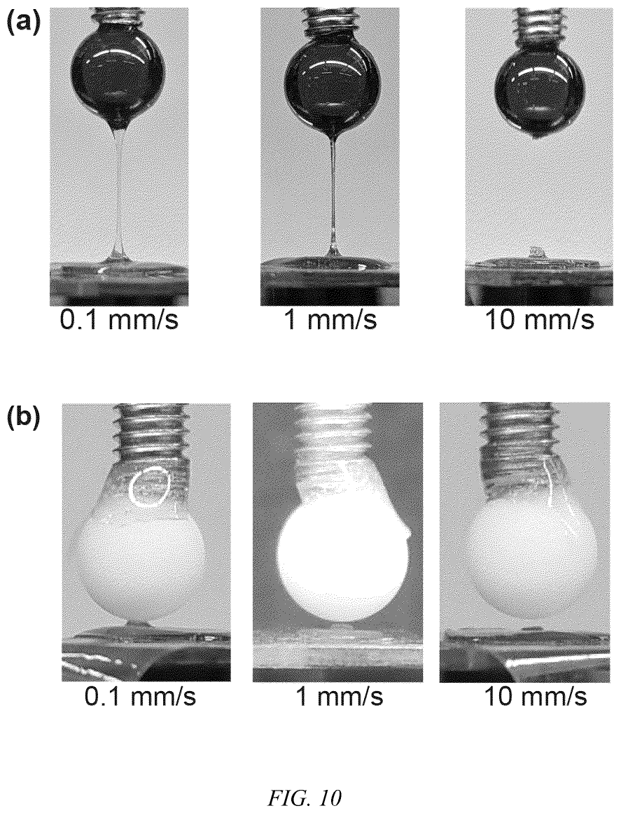

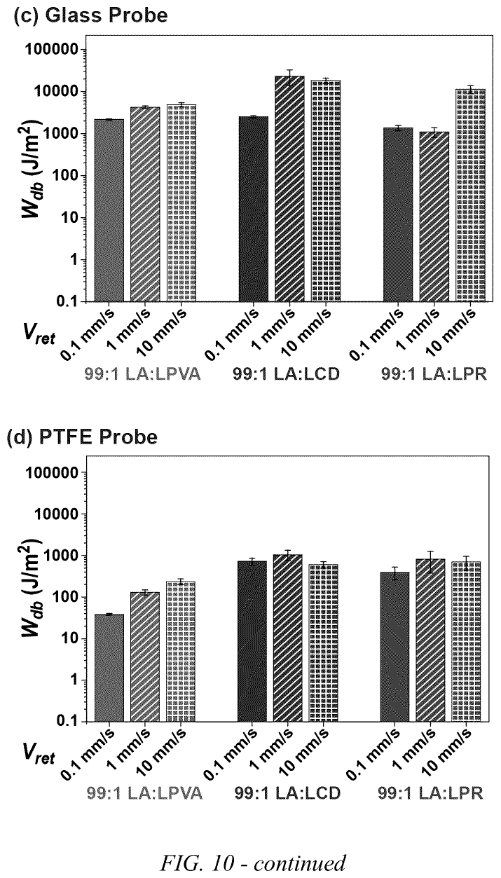

Example 9—Effect of Retraction Rate: To investigate the rate dependence of adhesion, we performed probe-tack tests at increasing retraction rates (V ret) of 0.1, 1, and 10 mm/s (FIG. 10). On glass, photographs (FIG. 10a) show the formation a filament during retraction, which remains unbroken as the sample is stretched up to 50 mm at retraction rates of 0.1 or 1 mm/s, whereas the filament snaps off at a displacement of 6.8 mm at 10 mm/s. On PTFE (FIG. 10b), adhesive failure occurs at a shorter distance (0.88 mm at Vᵣₑₜ=0.1 mm/s, 0.58 mm at Vᵣₑₜ=1 mm/s, 0.66 mm at Vᵣₑₜ=10 mm/s). In general, a trend of increasing W_{db} is observed with increasing Vᵣₑₜ. This effect is most pronounced for 99:1 LA:LACD on glass, which is remarkably strong (W_{db}=23,000 J/m² at 1 mm/s and 18,000 J/m² at 10 mm/s). The 99:1 LA:LAPR bond is also very strong (W_{db}=13,000 J/m²) at 10 mm/s.

The increase in work of debonding can be related to the frequency sweep data, since Vᵣₑₜ can be equated to the rheological angular frequency (@) by the equation 2:

$${V}_{ret} = \frac{h ω}{2 π} \qquad ( 2 )$$

where h is the sample thickness. [Callies, X.; Fonteneau, C.; Pensec, S.; Bouteiller, L.; Ducouret, G.; Creton, C. Adhesion and non-linear rheology of adhesives with supramolecular crosslinking points. Soft Matter 2016, 12, 7174-7185.] Using this relation we attempt to understand, even predict, the adhesive behavior of a sample based on its rheological frequency sweep. Considering the sample LA/LAPR 99:1, we observe that the @ is 1.2 rad/s at V ret=0.1 mm/s (with the value of h being 0.520 mm, based on the sample thickness used for rheology). We do not observe a significant change in work of debonding for LA/LAPR 99:1 composites between V ret of 0.1 and 1 mm/s but as we proceed to 10 mm/s the adhesion energy increases significantly. This rate-dependent adhesive behavior can be tracked to the dynamic moduli at the corresponding @ values. At ˜1.2 rad/s and ˜12 rad/s the storage and loss modulus are significantly far apart but at higher frequencies, the viscous dissipation increases considerably making the formulation a stronger adhesive. An elastic material with good viscous dissipation exhibits excellent adhesion properties. Similarly, the rate dependence of the other adhesives can be correlated to their frequency sweep data. The rheological frequency sweep of 0.1-100 rad/s covers all associated V ret values for the samples tested at different retraction rates.

Example 10—Load-Bearing Demonstrations in Air and Water: We selected the 99:1 LA:LAPR adhesive for further demonstrations of load-bearing performance, since it was found to be the most resistant to age-related loss of tack (FIG. 5). 40 mg of the adhesive was prepared on glass or PTFE slides, which were bonded together with uncoated slides in a sandwich geometry under the external pressure of a 1-kg weight for, at least, 2 hours to ensure consistent pressure treatment. A 100-g weight was then affixed from the sandwich assembly and suspended from it under the force of gravity. The adhesive bears the weight without failure for at least 10 minutes on both substrates (FIG. 9). In the absence of a base or salts, poly(LA) is hydrophobic. Water is structured around LA-modified polyrotaxane out to a distance of 5° A from its surface, beyond which water is considered unstructured and free. These considerations led us to reason that the 99:1 LA:LAPR adhesive might perform well underwater, with the structured water layer providing a screen to prevent aqueous swelling. Indeed, the 40 mg of adhesive also bears the 100-g weight under water for at least 10 minutes. Significantly higher loads of 2 kg and 4 kg were lifted using a similar procedure and assembly, but with 100 mg of 99:1 LA:LAPR adhesive formulation.

Strong pressure-sensitive supramolecular adhesives can be formulated from poly(lipoic acid) and lipoated cross-linkers present at only 1% w/v concentration. Importantly these PSAs can be all-organic and bio-friendly, devoid of any metal ions or petroleum-based cross linkers (at least in the case of lipoated cyclodextrin; the PEG backbone of the polyrotaxane cross-linker LACD is derived from petroleum, but it can be replaced in principle by green polymers such as poly(lactic acid), poly (ϵ-lysine), or silk fibroin). The work of debonding on glass and PTFE has been quantified for these adhesives in spherical probe-tack tests, with the 99:1 LA:cross-linker formulas exhibiting strong adhesion in both cases (up to 2,500 J/m2 on glass and 450 J/m² on PTFE at a 0.1 mm/s retraction rate), outperforming a commercial PSA (UHU Tac). The work of debonding (W_{db}) tends to increase with decreasing cross-linker ratio, as well as increasing retraction rate (Vret) up to 10 mm/s. We also observed that W_{db} generally correlates inversely with the stress relaxation times (τ_{R}) and the viscoelastic moduli (G′, G″) measured by indentation tests and shear rheology, respectively. Unlike in pure poly(lipoic acid), a poor adhesive which rapidly crystallizes via ring-opening depolymerization, the lipoated cross-linkers retard crystallization substantially, but not completely. While the strongest adhesive was found to comprise a 99:1 ratio of LA:LACD when freshly prepared (W_{db}>20,000 J/m² at Vret=10 mm/s), only the 99:1 LA:LAPR formula on glass, which forms only a slightly weaker bond than 99:1 LA:LACD, is resistant to significant loss in tack upon aging for 4 weeks. The bio-friendly supramolecular cross-linkers also outperform the non-supramolecular LAPVA polymer employed as a control. We thus infer that their supramolecular dynamics-host-guest exchange in the case of LACD and ring-sliding in the case of LAPR-enhances adhesion, likely by providing pathways to dissipate mechanical stress as the adhesive is deformed. The strong and temporally stable slide-ring adhesive (99:1 LA:LAPR) was further subjected to load bearing tests, with 40 mg of aged material easily withstanding the force of a suspended 2-kg weight in air and a 100-g weight underwater. These supramolecular adhesives may be of particular interest for applications in biomedicine or sustainable materials that demand eco- and bio-friendly bonds.

### Definitions

As used herein, the term “composition” is intended to encompass a product comprising the specified ingredients in the specified amounts, as well as any product which results, directly or indirectly, from combination of the specified ingredients in the specified amounts.

As used throughout the entire application, the terms “a” and “an” are used in the sense that they mean “at least one”, “at least a first”, “one or more” or “a plurality” of the referenced components or steps, unless the context clearly dictates otherwise. For example, the term “a cell” includes a plurality of cells, including mixtures thereof.

The term “and/or” wherever used herein includes the meaning of “and”, “or” and “all or any other combination of the elements connected by said term”.

The term “about” or “approximately” as used herein means within 20%, preferably within 10%, and more preferably within 5% of a given value or range.

Other than in the operating examples, or unless otherwise expressly specified, all of the numerical ranges, amounts, values and percentages such as those for amounts of materials, times and temperatures of reaction, ratios of amounts, values for molecular weight (whether number average molecular weight (“Mₙ”) or weight average molecular weight (“M_{w}”), and others in the following portion of the specification may be read as if prefaced by the word “about” even though the term “about” may not expressly appear with the value, amount or range. Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used.

As used herein, the term “comprising” is intended to mean that the products, compositions and methods include the referenced components or steps, but not excluding others. “Consisting essentially of” when used to define products, compositions and methods, shall mean excluding other components or steps of any essential significance. Thus, a composition consisting essentially of the recited components would not exclude trace contaminants and pharmaceutically acceptable carriers. “Consisting of” shall mean excluding more than trace elements of other components or steps.

As used herein, the phrases “for example,” “for instance,” “such as,” or “including” are meant to introduce examples that further clarify more general subject matter. These examples are provided only as an aid for understanding the disclosure, and are not meant to be limiting in any fashion.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

All references cited in the present application are incorporated in their entirety herein by reference to the extent not inconsistent herewith.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween. Now that the invention has been described,

What is claimed is:

1. A method of preparing an adhesive film comprising the steps of:
mixing lipoated compounds with lipoic acid (LA) at mass ratios of about 4:1 to about 200:1 LA:lipoated compound in anhydrous DMSO to create an adhesive solution; and
casting the adhesive solution to form an adhesive film.

2. The method of preparing an adhesive film according to claim 1 wherein the lipoated compounds are selected from the group consisting of LA-functionalized α-cyclodextrin (LACD), LA-functionalized poly(vinyl alcohol) (LAPVA), or adamantamide-capped PEG⊂(α-CD)n PRs (LAPR).

3. The method of preparing an adhesive film according to claim 2 wherein the mass ratio of LA:lipoated compound is about 99:1 to about 9:1.

4. The method of preparing an adhesive film according to claim 2 wherein the mass ratio of LA:lipoated compound is about 120:1 to about 4:1.

5. The method of preparing an adhesive film according to claim 1 wherein the adhesive film is incubated at about 60 C or higher for 6 or more hours to evaporate DMSO and initiate the ring-opening polymerization of LA.

6. The method of preparing an adhesive film according to claim 5 wherein the casted adhesive solution is incubated at about 70 degrees C. or higher for 8 or more hours to evaporate DMSO completely and initiate the ring-opening polymerization of LA.

7. The method of preparing an adhesive film according to claim 1 wherein the lipoated compound is LA-functionalized α-cyclodextrin (LACD).

8. The method of preparing an adhesive film according to claim 7 wherein the mass ratio of LA:LACD is about 99:1 to about 9:1.

9. The method of preparing an adhesive film according to claim 7 wherein the mass ratio of LA:LACD is about 200:1 to about 4:1.

10. The method of preparing an adhesive film according to claim 1 wherein the lipoated compound is LA-functionalized adamantamide-capped PEG⊂(α-CD)n PRs (LAPR).

11. The method of preparing an adhesive film according to claim 7 wherein the mass ratio of LA:LAPR is about 99:1 to about 9:1.

12. The method of preparing an adhesive film according to claim 7 wherein the mass ratio of LA:LAPR is about 200:1 to about 4:1.

13. The method of preparing an adhesive film according to claim 1 wherein the adhesive film has a thickness of about 2 millimeters (mm) or less, about 1 millimeter (mm) or less, about 750 micrometers (μm) or less, about 500 μm or less, or about 250 μm or less.

14. The method of preparing an adhesive film according to claim 1 wherein the adhesive film has a thickness between about 500 μm to about 800 μm or about 400 μm to about 1 mm.

15. An adhesive film comprising a mixture of lipoic acid (LA) and lipoated cyclodextrin (LACD) formed into a thin sheet of about 1 millimeter (mm) or less in thickness.

16. The adhesive film according to claim 15 wherein the sheet comprises about 110:1 to about 90:1 by mass of LA:LACD.

17. The adhesive film according to one of claim 15 wherein the ratio of LA to cross-linker is about 99 LA:1 cross-linker to about 9:1 LA:1 cross-linker by mass.

18. The adhesive film according to one of claim 15 wherein the ratio of LA to cross-linker is about 150 LA:1 cross-linker to about 9 LA:1 crosslinker by mass.

19. A method of adhering a first structure to a second structure comprising the step of adhering a first side of the adhesive film according to claim 15 to a surface of the first structure and adhering a second side of the adhesive film to a surface to the second structure.

20. An adhesive film comprising a mixture of lipoic acid (LA) and lipoated polyrotaxane (LAPR) formed into a thin sheet of about 1 millimeter (mm) or less in thickness.

21. The adhesive film according to claim 19 wherein the sheet comprises about 110:1 to about 90:1 by mass of LA:LAPR.

22. The adhesive film according to one of claim 19 wherein the ratio of LA to cross-linker is about 99 LA:1 cross-linker to about 9:1 LA:1 cross-linker by mass.

23. The adhesive film according to one of claim 19 wherein the ratio of LA to cross-linker is about 150 LA:1 cross-linker to about 9 LA:1 crosslinker by mass.

24. A method of adhering a first structure to a second structure comprising the step of adhering a first side of the adhesive film according to claim 20 to a surface of the first structure and adhering a second side of the adhesive film to a surface to the second structure.
